(19) United States
(12) Patent Application Publication
(10) Pub. No.: US 2026/0264377 A1
(43) Pub. Date: Sep. 10, 2026

(54) VEHICLE WINDOW FILM WITH IMPROVED WORKABILITY AND METHOD FOR MANUFACTURING THE SAME

(71) Applicant: STEK CO., LTD., Seoul (KR)

(72) Inventors: Chang Suk LEE, Cheonan-si (KR); Sang Tae KIM, Cheonan-si (KR); Hye Ryeon LEE, Cheonan-si (KR); Yun Soo JUNG, Cheonan-si (KR); Yu Ri KIM, Cheonan-si (KR)

(73) Assignee: STEK CO., LTD., Seoul (KR)

(21) Appl. No.: 19/393,685

(22) Filed: Nov. 19, 2025

(30) Foreign Application Priority Data
Mar. 7, 2025 (KR) 10-2025-0029548

(51) Int. Cl. B32B 27/08; B32B 27/36; B32B 37/16; B32B 38/00

(52) U.S. Cl. CPC B32B 27/08; B32B 27/36; B32B 37/16; B32B 38/164; B32B 2250/02; B32B 2250/244; B32B 2255/10; B32B 2255/26; B32B 2307/306; B32B 2307/4026; B32B 2307/7376; B32B 2367/00; B32B 2605/00

(57) ABSTRACT

The present invention relates to a vehicle window film with improved workability and a method for manufacturing the same, wherein the vehicle window film of the present invention has excellent workability by increasing the sensitivity to heat during an application process using a highly heat-sensitive PET film, a low-temperature curing adhesive, a photoinitiator that is cured with a low UV light intensity, and the like, and a method for manufacturing a vehicle window film can minimize the thermal shrinkage of the PET film by optimizing the vehicle window film and heat curing conditions, and can minimize unwanted heat transfer to a substrate by first forming an adhesive layer.

### CROSS-REFERENCE TO RELATED APPLICATION

This application claims priority to and the benefit of Korean Patent Application No. 10-2025-0029548, filed on Mar. 7, 2025, the disclosure of which is incorporated herein by reference in its entirety.

### BACKGROUND

### 1. Field of the Invention

The present invention relates to a vehicle window film with improved workability and a method for manufacturing the same, and more particularly to a vehicle window film with excellent workability by increasing the sensitivity to heat during an application process using a highly heat-sensitive PET film, a low-temperature curing adhesive, a photoinitiator that is cured with a low UV light intensity, and the like, and a method for manufacturing a vehicle window film, which can minimize the thermal shrinkage of the PET film by optimizing heat curing conditions, and can minimize unwanted heat transfer to a substrate by first forming an adhesive layer.

### 2. Discussion of Related Art

Vehicle window films are attached to vehicle windows to provide functions such as UV light blockage, heat shielding, and personal privacy protection. Most window films are manufactured using a polyethylene terephthalate (PET) film, and the PET film is applied to glass windows through thermoforming in conformation with the curvature of the glass surface.

The front and rear windshields of a vehicle are usually so curved that thermoforming is essential. Variations in quality during the thermoforming process have a significant impact on the performance and appearance of a final product. In particular, since most vehicle window film products currently on the market provide similar performance levels, differences in thermoforming performance act as an important factor in determining the preference of an application worker.

Existing vehicle window films are produced at high temperatures by first performing the adhesive process during manufacturing. When a window film is manufactured so as to have a 2-ply structure, the window film is manufactured by separately coating an adhesion layer located between two substrate layers and an adhesive layer located between a substrate layer and an adherend, and the existing window film manufacturing process involves first coating the adhesion layer and then coating the adhesive layer. This causes a PET film to shrink due to heat, which results in the film not fitting accurately to the glass surface of a vehicle during thermoforming or causes deformation during application. Since most window films have heat-sensitive characteristics, their thermoforming performance is relatively insufficient, and application workers often have difficulties in applying the film properly.

### Related Art Documents

### Patent Document

Korean Patent Publication No. 10-2016-0149391

### SUMMARY OF THE INVENTION

Thus, a problem to be solved by the present invention is to provide a vehicle window film with excellent workability by increasing the sensitivity to heat during an application process using a highly heat-sensitive PET film, a low-temperature curing adhesive, a photoinitiator that is cured with a low UV light intensity, and the like.

Another problem to be solved by the present invention is to provide a method for manufacturing a vehicle window film, which can minimize the thermal shrinkage of the PET film by optimizing heat curing conditions, and can minimize unwanted heat transfer to a substrate by first forming an adhesive layer.

The problems of the present invention are not limited to the aforementioned technical problems, and other technical problems, which have not been mentioned, may be clearly understood by a person with ordinary skill in the art from the following description.

According to an embodiment of the present invention for solving the above problems, provided is a vehicle window film including: an adhesive layer including a polyacrylate resin and a curing agent; a first substrate layer disposed on the adhesive layer and including a polyethylene terephthalate (PET) film; a color layer disposed on the first substrate layer and including a polyurethane resin, a curing agent, and a color pigment; a second substrate layer disposed on the color layer and including a PET film; and a hard coating layer disposed on the second substrate layer and including an acrylate monomer and a photoinitiator.

One or more of the PET films of the first and second substrate layers may be a highly heat-sensitive PET film having a CTE of 30 or more in the MD direction and 22 or more in the TD direction, the adhesive layer may include 100 parts by weight of a polyacrylate resin and 0.5 to 5 parts by weight of a curing agent, the color layer includes 100 parts by weight of isophthalic acid-based polyol, 5 to 20 parts by weight of adipic acid and diethylene glycol-based polyol, 5 to 20 parts by weight of an HDI trimer-based isocyanate curing agent, and 1 to 30 parts by weight of a color pigment, and the hard coating layer may include 100 parts by weight of an acrylate monomer and 0.1 to 5 parts by weight of a photoinitiator.

A vehicle window film may be provided, in which the adhesive layer has a thickness of 5 to 15 μm, the first substrate layer has a thickness of 10 to 50 μm, the color layer has a thickness of 5 to 15 μm, the second substrate layer has a thickness of 13 to 75 μm, and the hard coating layer has a thickness of 1 to 6 μm.

A method for manufacturing the vehicle window film may include: (a) forming an adhesive layer on one surface of a first substrate layer; (b) forming a hard coating layer on one surface of a second substrate layer; (c) forming a color layer on the other surface of the second substrate layer; and (d) laminating the color layer on the other surface of the first substrate layer, wherein the adhesive layer may include a polyacrylate resin and a curing agent, the first substrate layer and the second substrate layer may each include a polyethylene terephthalate (PET) film, the color layer may include a polyurethane resin, a curing agent, and a color pigment, and the hard coating layer may include an acrylate monomer and a photoinitiator.

In step (a), the adhesive layer may be formed by coating the first substrate layer with a coating solution containing a polyacrylate resin and a curing agent at a temperature of 100 to 140° C and drying the coating,

in step (b), the hard coating layer may be formed by coating the second substrate layer with a coating solution containing an acrylate monomer and a photoinitiator at a temperature of 60 to 100° C and a UV light intensity of 100 to 300 mJ and drying and curing the coating,

in step (c), the color layer may be formed by coating the second substrate layer with a coating solution containing a polyurethane resin, a curing agent, and a color pigment at a temperature of 40 to 80° C and drying the coating,

the adhesive layer may include 100 parts by weight of the polyacrylate resin and 0.5 to 5 parts by weight of the curing agent,

the color layer may include 100parts by weight of isophthalic acid-based polyol, 5 to 20 parts by weight of adipic acid and diethylene glycol-based polyol, 5 to 20 parts by weight of an HDI trimer-based isocyanate curing agent, and 1 to 30 parts by weight of a color pigment, and

the hard coating layer may include 100 parts by weight of the acrylate monomer and 0.1 to 5 parts by weight of the photoinitiator.

Specific details of other embodiments are included in the detailed description.

### BRIEF DESCRIPTION OF THE DRAWINGS

FIG. 1 is a cross-sectional view showing a stacked structure of a vehicle window film according to an embodiment of the present invention.

FIG. 2 is a set of photographs showing the thermal sensitivity of the vehicle window films according to the experimental examples of the present invention as a function of temperature.

FIG. 3 is a set of photographs showing an evaluation of the scratch resistance of the vehicle window films according to the experimental examples of the present invention.

### DETAILED DESCRIPTION OF EXEMPLARY EMBODIMENTS

The benefits and features of the present invention, and the methods of achieving the benefits and features will become apparent with reference to embodiments to be described below in detail. However, the present invention is not limited to the embodiments to be disclosed below and may be implemented in various other forms, and the embodiments are only provided for rendering the disclosure of the present invention complete and for fully representing the scope of the invention to a person with ordinary skill in the technical field to which the present invention pertains, and the present invention will be defined only by the scope of the claims.

The terms used in the present specification are used merely to describe embodiments, and are not intended to limit the present invention. In the present specification, the 'and/or' includes each and all combinations of one or more of the items mentioned. Further, the singular form includes the plural forms unless specifically stated in a phrase. The terms 'comprises' and/or 'comprising' used in the specification do not exclude the presence or addition of one or more other constituent elements in addition to the referenced constituent elements. The numerical range indicated by using '-' or 'to' indicates a numerical range including values described before and after it as a lower limit and an upper limit, respectively, unless otherwise stated. 'About' or 'approximately' means a value or numerical range within 20 % of the value or numerical range described thereafter.

In describing the constituent elements of the examples of the present invention, terms such as first, second, A, B, (a), and (b) may be used. These terms are merely for distinguishing one constituent element from another, and the nature, turn, or order of the corresponding constituent element is not limited by the term.

Since the size and thickness of each component shown in the drawings may be arbitrarily shown for the convenience of explanation, the present invention is not necessarily limited to those shown in the drawings. In the drawings, in order to clearly express several layers and regions, their thickness may be enlarged. Moreover, in the drawings, the thicknesses of some layers and regions may be exaggerated for convenience of explanation.

A case where a part such as a layer, a film, a region, and a plate is present “under” or “at a lower portion of” another part includes not only a case where the part is present “immediately under” another part, but also a case where still another part is present therebetween, unless otherwise specified. In addition, a case of being 'above' or 'on' a reference part means being located above or below the reference part, and does not necessarily mean being located 'above' or 'on' in the opposite direction of gravity.

The description 'on a plane' means that a target part is viewed from above, and the description 'on a cross section' means that the target part is cut vertically and viewed from the side.

Unless otherwise defined, all the terms (including technical and scientific terms) used in the present specification will be able to be used as a meaning which may be commonly understood to a person with ordinary skill in the art to which the present invention pertains. In addition, the terms defined in generally used dictionaries are not to be interpreted ideally or excessively unless clearly and specifically defined.

Moreover, in describing the embodiments of the present invention, when it is determined that the specific description of relevant known configurations or functions obstructs the understanding for the embodiments of the present invention, the detailed description thereof will be omitted.

Hereinafter, the embodiments of the present invention will be described in detail with reference to the accompanying drawings.

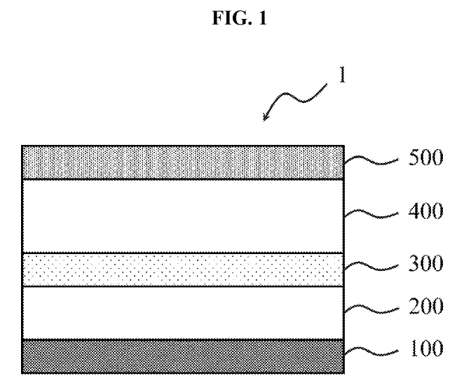

FIG. 1 is a cross-sectional view showing a stacked structure of a vehicle window film according to an embodiment of the present invention.

Referring to FIG. 1, a vehicle window film 1 includes an adhesive layer 100, a first substrate layer 200 disposed on the adhesive layer 100, a color layer 300 disposed on the first substrate layer 200, a second substrate layer 400 disposed on the color layer 300, and a hard coating layer 500 disposed on the second substrate layer 400.

Furthermore, the vehicle window film 1 may further include a release film disposed under the adhesive layer 100.

### Adhesive layer

The adhesive layer (100) may include a polyacrylate resin and a curing agent. The adhesive layer may be a layer including a transparent pressure-sensitive adhesive (PSA) material. The adhesive layer does not cause problems with visibility due to its good adhesion to the substrate, allowing the vehicle window film of the present invention to be stably attached to the front or rear glass window of an automobile.

In the related art, in order to prevent the transfer phenomenon in which an adhesive remains on an automobile glass when an vehicle window film is removed, surface treatment processes such as corona treatment and primer treatment were performed on the surface of a first substrate layer to improve attachment properties between the first substrate layer and an adhesive layer, but since the adhesive layer in the vehicle window film of the present invention has the components described above, it is possible to maintain high attachment strength with the first substrate layer without a separate surface treatment process, thereby preventing the transfer phenomenon. However, the embodiments of the present invention are not limited thereto, and it is needless to say that the surface of the first base layer can be subjected to the above-described separate surface treatment.

The adhesive layer may include 100parts by weight of a polyacrylate resin and 0.5 to 5 parts by weight of a curing agent. The curing agent may be an epoxy curing agent. When the composition of the adhesive layer is within the above range, the adhesive strength with the first substrate layer is sufficient without a separate surface treatment, so that the transfer phenomenon can be prevented, and visibility is good.

The adhesive layer may be formed by coating with a coating solution having the above composition at a temperature of 100to 140° C, specifically 110 to 130° C, and drying and curing the coating. In this case, the process speed may be 10 to 50 m/min, specifically 20 to 40 m/min. The coating solution may further contain 20 to 80 parts by weight of a solvent.

The thickness of the adhesive layer may be 5 to 15 μm, specifically 6 to 10 μm, and more specifically 7 to 9 μm. When the thickness of the adhesive layer is within the above range, the adhesive strength with the first substrate layer is sufficient without a separate surface treatment, so that the transfer phenomenon can be prevented, and visibility is good.

### Substrate layer

The vehicle window film of the present invention may include a double substrate layer 200, 400 called a 2-ply structure, which is a structure capable of improving the performance and durability of a vehicle window film.

Each substrate layer may include a polyethylene terephthalate (PET) film. The PET used in the substrate layer of the present invention may include a highly heat-sensitive material that has a higher heat sensitivity than general PET materials. Since the highly heat-sensitive PET of the present invention is characterized by beginning to shrink at a lower temperature than general PET, it can be quickly formed in conformation with the curved surface of the front or rear glass of an automobile by applying heat during application. Furthermore, since the highly heat-sensitive PET of the present invention is a highly transparent film with excellent transmittance, the highly heat-sensitive PET of the present invention provides good visibility.

The highly heat-sensitive PET film of the present invention may have a coefficient of thermal expansion (CTE) of 30 or more in the machine direction (MD) direction and 22 or more in the transverse direction (TD) direction. Specifically, the highly heat-sensitive PET film may have a CTE of 35 to 50 in the MD direction and 22 to 40 in the TD direction. Further, the highly heat-sensitive PET film of the present invention may have a higher CTE than general PET films. Specifically, the highly heat-sensitive PET film may have a higher CTE in both the MD and TD directions than general PET films, and in an embodiment, the highly heat-sensitive PET film may have a CTE by 10 or more higher in the MD direction and 5 or more higher in the TD direction. The CTE may be a value obtained by performing thermal analysis (TMA) under the conditions of a tension of 0.5 N in the MD direction and a tension of 0.05 N in the TD direction based on an interval of 50 to 80° C.

In an exemplary embodiment, the CTE of the highly heat-sensitive PET film may be about 37.6 and 25.9 in the MD and TD directions, respectively, whereas the CTE of a general PET film may be about 26.9 and 20.5 in the MD and TD directions, respectively. However, the embodiments of the present invention are not limited thereto.

Both the first substrate layer and the second substrate layer may include a highly high-sensitive PET film, but the layers are not limited thereto, and only one substrate layer of the first substrate layer and the second substrate layer may include a highly heat-sensitive PET film.

In an embodiment, each substrate layer may be a highly heat-sensitive PET film including only 100% highly heat-sensitive PET.

The thickness of the first substrate layer may be 10 to 50 μm, specifically 10 to 30 μm, and more specifically 10 to 20 μm. The thickness of the second substrate layer may be 13 to 75 μm, specifically 15 to 40 μm, and more specifically 20 to 30 μm. When the thickness of each substrate layer is within the above range, application is facilitated and the performance and durability of the vehicle window film can be secured.

### Color layer

The color layer 300 may include a polyurethane resin, a curing agent, and a color pigment. The color layer also serves to adhere the first substrate layer and the second substrate layer, and thus may correspond to a pigment adhesion layer. The curing agent may be an isocyanate curing agent.

A urethane resin that can be stably cured even at low temperatures in the color layer is applied to minimize the heat received by the substrate during the production process, thereby increasing sensitivity to heat when a product is actually applied, and as a result, workability is improved.

In particular, unlike existing adhesives that are sensitive to heat at high temperatures, a low-temperature curing adhesive is cured at low temperatures, so that the deformation or shrinkage of vehicle window films can be minimized during the thermoforming process.

In addition, since the color layer is an adhesion layer made of a urethane resin, the color layer increases the stiffness of a product, so that when installers handle a film, the film maintains its shape without sagging, thereby facilitating workability.

The color layer includes pigments that implement the color, and these have weather resistance that prevents color change even when exposed to sunlight for a long period of time, and may be made of a material that does not cause problems with visibility through the headlights of other vehicles during driving at night.

The color layer may include 100 parts by weight of a polyurethane resin, 5 to 20 parts by weight of a curing agent, and 1 to 30 parts by weight of a color pigment. The color pigment may include one or more selected from the group consisting of a black pigment, a blue pigment, a red pigment, and a yellow pigment. In an exemplary embodiment, the color pigments may include 4 to 6 parts by weight of a black pigment, 1 to 3 parts by weight of a blue pigment, 1 to 2 parts by weight of a red pigment, and 0.1 to 1 part by weight of a yellow pigment. However, the embodiments of the present invention are not limited thereto.

The polyurethane resin may be a low-temperature curing adhesive component. The low-temperature curing adhesive component may contain isophthalic acid-based polyol as a main agent and adipic acid and diethylene glycol-based polyol as additives. The curing agent may be an HDI trimer-based isocyanate curing agent.

In an exemplary embodiment, the color layer may include 100 parts by weight of isophthalic acid-based polyol, 5 to 20 parts by weight of adipic acid and diethylene glycol-based polyol, 5 to 20 parts by weight of an HDI trimer-based isocyanate curing agent, and 1 to 30 parts by weight of a color pigment. When the composition of the color layer is within the above range, the film can be stably cured even at low temperatures, so that the film has high sensitivity to heat when a product is applied, improves workability and maintains its shape without sagging, and may secure weather resistance and visibility.

The color layer may be formed by coating with a coating solution having the above composition at a temperature of 40 to 80° C, specifically 50 to 70° C, and drying and curing the coating. In this case, the process speed may be 10 to 50 m/min, specifically 20 to 40 m/min.

The thickness of the color layer may be 5 to 15 μm, specifically 6 to 12 μm, and more specifically 7 to 10 μm. When the thickness of the color layer is within the above range, the film can be stably cured even at low temperatures, so that the film has high sensitivity to heat when a product is applied, improves workability and maintains its shape without sagging, and may secure weather resistance and visibility.

### Hard coating layer

The hard coating layer may include an acrylate monomer and a photoinitiator.

The hard coating layer may be disposed on the surface of the vehicle window film to prevent scratches and used in order to improve durability. Although the hard coating layers of conventional vehicle window films have a normal level of hardness (1 H or less) and have a protective function, the hard coating layer of the present invention has a hardness of 2 H or more based on the pencil hardness scale, and thus may exhibit more enhanced performance.

In addition, the hard coating layer of the present invention is designed so as to achieve sufficient curing even with a relatively low UV light intensity during UV curing, and this reduces the impact of temperature on the vehicle window film to minimize thermal damage to the vehicle window film and allow the vehicle window film to quickly respond to temperature during application, enabling application workers to perform application more conveniently and quickly.

In an embodiment, the photoinitiator may include one or more of hydroxycyclohexyl phenyl ketone and bis(2,4,6-trimethylbenzoyl) phenylphosphine oxide. However, the embodiments of the present invention are not limited thereto.

The hard coating layer may include 100 parts by weight of an acrylate monomer and 0.1 to 5 parts by weight of a photoinitiator. When the composition of the hard coating layer is within the above range, sufficient curing is achieved even with a relatively low UV light intensity, thereby minimizing thermal damage to the vehicle window film and facilitating application.

The hard coating layer may be formed by coating with a coating solution having the above composition at a temperature of 60 to 100° C, specifically 70 to 90° C and a UV light intensity of 100 to 300 mJ, specifically 150 to 250 mJ, and drying and curing the coating. In this case, the process speed may be 10 to 50 m/min, specifically 20 to 40 m/min.

The thickness of the hard coating layer may be 1 to 6 μm, specifically 1 to 5 μm, and more specifically 2 to 4 μm. When the thickness of the hard coating layer is within the above range, sufficient curing is achieved even with a relatively low UV light intensity, thereby minimizing thermal damage to the vehicle window film and facilitating application.

### Release film

The release film may include a PET film. The release film may further include silicone.

The release film may protect the adhesive layer until the vehicle window film of the present invention is attached to the painted surface of a vehicle. It is preferred that the release film is easily removed by an application worker during application of the vehicle window film, and has an appropriate peel strength to prevent lifting (tunneling) between the release film and the adhesive layer. In an embodiment, the release film may include any common release film that has an appropriate peel strength and has difficulty in increasing its peel strength over time while being attached to the adhesive layer.

The thickness of the release film may be 10 to 50 μm, specifically 15 to 40 μm, and more specifically about 20 to 30 μm.

### UV blocking agent and IR blocking agent

In an embodiment of the present invention, the adhesive layer 100, the color layer 300, and/or the hard coating layer 500 may further include one or more of a UV blocking agent and an IR blocking agent.

The UV blocking agent and the IR blocking agent may serve to block ultraviolet and infrared rays in order to protect the skin of a driver in a vehicle window film and suppress the temperature inside an automobile from increasing.

The IR blocking agent may include one or more selected from the group consisting of carbon, tungsten oxide (WO₃), and ATO.

Carbon is made of extremely small particles of carbon (graphite) in nanometer units, and is dispersed in the adhesive layer, color layer, or hard coating layer to block sunlight. For this purpose, carbon usually serves to block visible light, and may color the film depending on its content. Unlike general dyes that are added for coloring, carbon is in the form of dispersed particles, so that carbon can also block some of the sunlight in wavelength bands other than visible light.

Tungsten oxide (WO₃) serves to block a wavelength range of 900 to 1,500 nm. Tungsten oxide (WO₃) may be mixed and added in the form of a nanometer-sized fine powder dispersed in a dispersion. Haze may vary depending on the degree of dispersion in the dispersion and the size of the fine powder.

The haze refers to a phenomenon in which, when light passes through a transparent substance, light rays are diffused by the substance in addition to being reflected or absorbed, resulting in an opaque and cloudy appearance. The haze as described above is defined as the degree to which incident light is dispersed, and is defined as the fraction of light scattered by ±2.5° or more. Since the haze as described above cause the obstruction of visual field in films attached to glass, the haze needs to be suppressed as much as possible.

ATO is antimony-doped tin oxide, and serves to block a wavelength of 1,500 nm or more. ATO may be mixed and added in the form of a fine powder dispersed in a dispersion, as in the tungsten oxide. In addition, haze may vary depending on the degree of dispersion in the dispersion and the size of the fine powder, as in the tungsten oxide.

In an embodiment, the IR blocking agent may further include ITO. ITO is indium tin oxide, can block shorter wavelengths than ATO, and also shows a high blocking rate even at longer wavelengths. Generally, ITO scarcely has almost no haze and shows very transparent characteristics.

The IR blocking agent according to an embodiment of the present invention may be added in the form of a dispersion dispersed in an organic solvent such as MEK, MIBK, PM, or TOL, and a dispersant may be added, if necessary.

As the UV blocking agent, it is possible to use a substance having ultraviolet blocking performance generally used.

The UV or IR blocking agent may be further included in the adhesive layer, color layer or hard coating layer in an amount of 1 to 10 parts by weight in addition to the existing components.

The method for manufacturing a vehicle window film according to an embodiment of the present invention includes: (a) forming an adhesive layer on one surface of a first substrate layer, (b) forming a hard coating layer on one surface of a second substrate layer, (c) forming a color layer on the other surface of the second substrate layer, and (d) laminating the color layer on the other surface of the first substrate layer.

In addition, the method may further include (a-1) laminating a release film on the surface of the adhesive layer.

In step (a), the adhesive layer may be formed by coating with a coating solution at a temperature of 100to 140° C, specifically 110 to 130° C, and drying and curing the coating. The process speed may be 10 to 50 m/min, specifically 20 to 40 m/min.

In step (b), the hard coating layer may be formed by coating with a coating solution at a temperature of 60 to 100° C, specifically 70 to 90° C and a UV light intensity of 100 to 300 mJ, specifically 150 to 250 mJ, and drying and curing the coating. The process speed may be 10 to 50 m/min, specifically 20 to 40 m/min.

In step (c), the color layer may be formed by coating with a coating solution at a temperature of 40 to 80° C, specifically 50 to 70° C, and drying and curing the coating. The process speed may be 10 to 50 m/min, specifically 20 to 40 m/min.

A description of the coating solution and each layer will be omitted because it has been described above.

Hereinafter, the present invention will be described through Experimental Examples, but it is obvious that the effects of the present invention are not limited by the following Experimental Examples.

### Preparation Examples

### Example 1

The lower surface of a PET film substrate layer having a thickness of 13 μm was coated with a coating solution containing 100 parts by weight of a polyacrylate adhesive resin, 2 parts by weight of a curing agent, and 50 parts by weight of a solvent at a chamber temperature of 120° C and a process speed of 30 m/min. The coating was dried and cured to form a transparent adhesive layer having a thickness of 8 μm. A release-treated PET film substrate layer having a thickness of 23 μm was laminated on the lower surface of the transparent adhesive layer to manufacture a primary semi-finished product.

The upper surface of a heat-sensitive, highly transparent PET film substrate layer having a thickness of 23 μm were coated with a coating solution containing 100 parts by weight of an acrylate monomer and 1 part by weight of a photoinitiator under the conditions of a chamber temperature of 80° C, a process speed of 30 m/min, and a UV light intensity of about 200 mJ. The coating was dried and cured to form a hard coating layer having a thickness of 3 μm, thereby manufacturing a secondary semi-finished product.

The uncoated surface (the surface opposite to the surface to which the hard coating was applied) of the secondary semi-finished product was coated with a coating solution containing 100 parts by weight of a low-temperature curing resin, 10 parts by weight of a curing agent, 5 parts by weight of a black pigment, 2 parts by weight of a blue pigment, 1.5 parts by weight of a red pigment, and 0.5 parts by weight of a yellow pigment at a chamber temperature of 60° C and a process speed of 30 m/min. The coating was dried and cured to form a color layer (pigment adhesion layer) having a thickness of 8 μm. The color layer was laminated on the uncoated surface (the surface opposite to the surface to which the transparent adhesive layer was applied) of the primary semi-finished product to manufacture the vehicle window film of a final finished product.

### Comparative Example 1

A vehicle window film was manufactured in the same manner as in Example 1, except that the uncoated surface of the secondary semi-finished product was coated with a coating solution containing 100 parts by weight of the acrylate resin, 2 parts by weight of the curing agent, 5 parts by weight of the black pigment, 2 parts by weight of the blue pigment, 1.5 parts by weight of the red pigment, and 0.5 parts by weight of the yellow pigment at a chamber temperature of 120° C and a process speed of 30 m/min when the color layer was formed.

### Comparative Example 2

A vehicle window film was manufactured in the same manner as in Example 1, except that a general highly transparent PET film was used as the substrate layer when the secondary semi-finished product was manufactured.

### Comparative Example 3

A vehicle window film was manufactured in the same manner as in Example 1, except that the color layer was formed in the same manner as in Comparative Example 1 and the secondary semi-finished product was manufactured in the same manner as in Comparative Example 2.

### Comparative Example 4

A vehicle window film was manufactured in the same manner as in Example 1, except that a substance requiring a higher light intensity was used as the photoinitiator and the substrate layer was coated under a UV light intensity condition of about 350 mJ when the secondary semi-finished product was manufactured.

### Comparative Example 5

A color layer (pigment adhesion layer) was formed on the lower surface of a heat-sensitive, highly transparent PET film substrate layer having a thickness of 23 μm in the same manner as in Example 1. A PET film substrate layer having a thickness of 13 μm was laminated on the lower surface of the color layer to manufacture a primary semi-finished product.

A hard coating layer was formed on the uncoated surface (the surface opposite to the surface to which the color layer of the 23-μm thick heat-sensitive highly transparent PET film was applied) of the first semi-finished product in the same manner as in Example 1 to manufacture a secondary semi-finished product.

A transparent adhesive layer was formed in the same manner as in Example 1 on the uncoated surface (the surface opposite to the surface to which the color layer of the 13-μm thick PET film was applied) of the secondary semi-finished product. A release-treated PET film substrate layer having a thickness of 23 μm was laminated on the lower surface of the transparent adhesive layer to manufacture the vehicle window film of a final finished product.

### Experimental Example 1

The thermal sensitivity of the vehicle window film of the present invention as a function of temperature was evaluated.

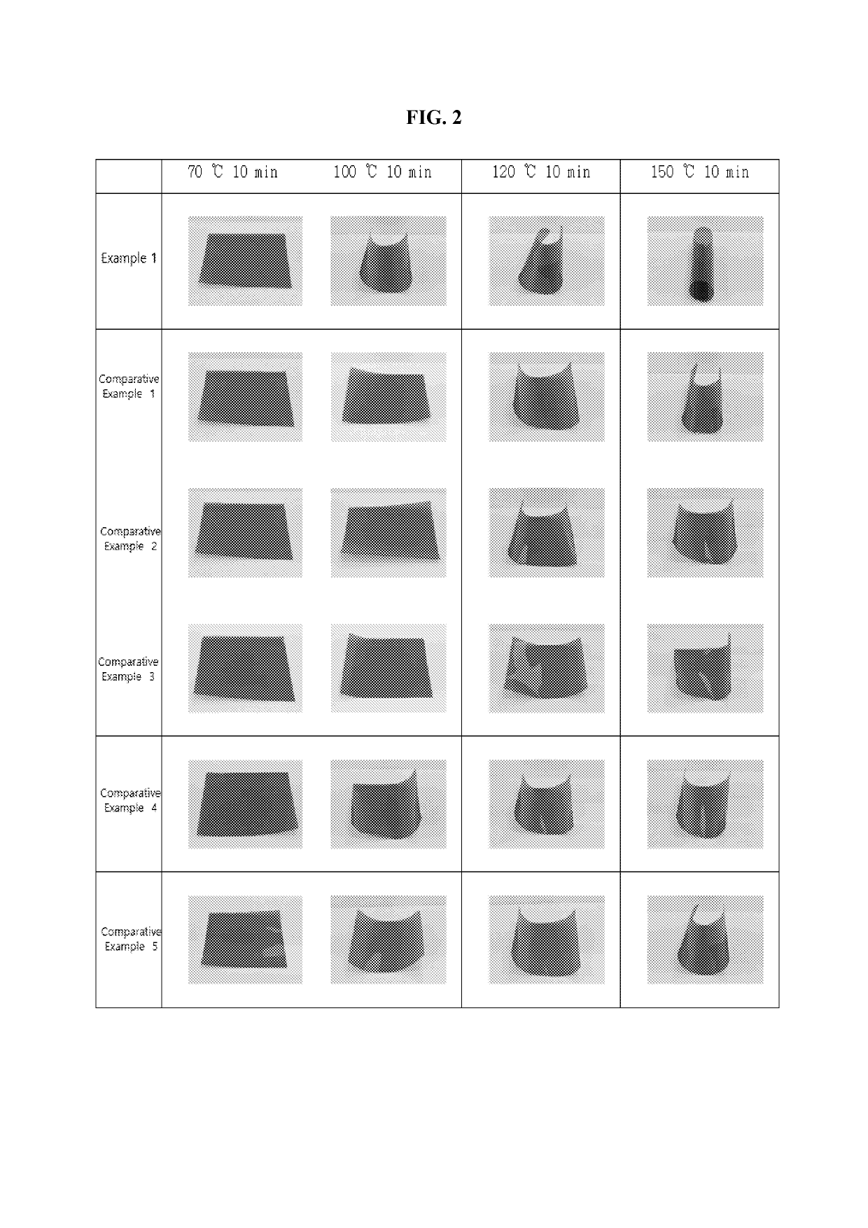

The vehicle window films of the example and the comparative examples were cut to a certain size (100 x 100 mm), placed in a hot air oven set at different temperatures for about 10 minutes, and removed, and then the appearance of each film was compared. FIG. 2 is a set of photographs showing the thermal sensitivity of the vehicle window films according to the experimental examples of the present invention as a function of temperature.

As shown in FIG. 2, it can be seen that the thermal sensitivity of Example 1 is more sensitive than those of the comparative examples. That is, it means that the vehicle window film of the present invention is easily applied because the product can be easily formed at a faster speed using a heat gun when an application worker applies the product to the curved glass of a vehicle.

### Experimental Example 2

The scratch resistance characteristics of the vehicle window film of the present invention were evaluated.

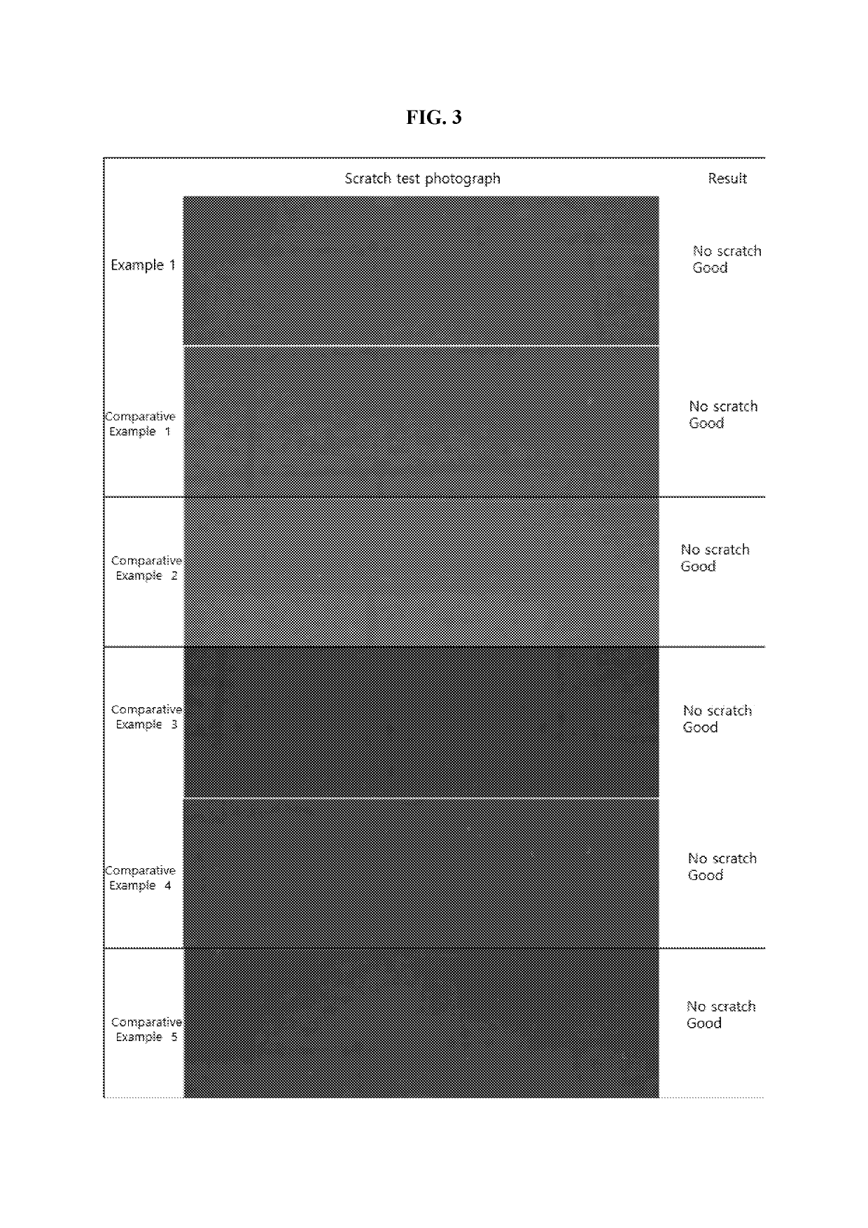

A rubbing tester was used to place Steel Wool (#0000) with a load of 750 g on the surfaces of the vehicle window films of the example and the comparative examples, and to confirm the degree of scratches remaining on the surface by reciprocating at 80 rpm. FIG. 3 is a set of photographs showing an evaluation of the scratch resistance of the vehicle window films according to the experimental examples of the present invention.

As shown in FIG. 3, it can be seen that the scratch resistance of Example 1 is at a level equal to or higher than those of the comparative examples. That is, it means that for the vehicle window film of the present invention, workability is improved and scratch resistance does not deteriorate.

The vehicle window film according to the embodiments of the present invention is easily applied to the curved glass surfaces of vehicles due to its high sensitivity at high temperatures, thereby improving workability. Further, the vehicle window film has excellent durability and functionality while maintaining the existing performance of vehicle window films (heat shielding, UV blockage, and the like).

In addition, the thermal shrinkage of a PET film is minimized and the heat curing conditions are improved, so that a vehicle window film can be easily formed in the application process.

That is, the efficiency and precision in the thermoforming process are significantly improved by minimizing the bubbles, wrinkles, irregular shapes of existing vehicle window films, so that workability is excellent.

Furthermore, the heat applied to a substrate film during manufacturing is minimized by first performing the adhesive process, so that the thermoforming performance of the film can be significantly improved and application workers can accurately fit the film to vehicle glass.

The effects according to the embodiments of the present invention are not limited to the contents exemplified above, and more various effects are included in the present specification.

As described above, although the present invention is mainly described with reference to the embodiments of the present invention, this is merely an example and does not limit the present invention, and it will be appreciated that a person with ordinary skill in the art to which the present invention pertains can make various modifications and applications which are not exemplified above within a range not departing from the essential characteristics of the embodiments of the present invention. For example, each constituent element specifically shown in the embodiments of the present invention can be modified and implemented. And differences related to these modifications and applications should be construed as being included in the scope of the present invention defined in the appended claims.

What is claimed is:

1. A vehicle window film comprising: an adhesive layer comprising a polyacrylate resin and a curing agent;
a first substrate layer disposed on the adhesive layer and comprising a polyethylene terephthalate (PET) film;
a color layer disposed on the first substrate layer and comprising a polyurethane resin, a curing agent, and a color pigment;
a second substrate layer disposed on the color layer and comprising a PET film; and
a hard coating layer disposed on the second substrate layer and comprising an acrylate monomer and a photoinitiator.

2. The vehicle window film of claim 1, wherein one or more of the PET films of the first and second substrate layers are a highly heat-sensitive PET film having a CTE of 30 or more in the MD direction and 22 or more in the TD direction.

3. The vehicle window film of claim 1, wherein the adhesive layer comprises 100 parts by weight of a polyacrylate resin and 0.5 to 5 parts by weight of a curing agent.

4. The vehicle window film of claim 1, wherein the color layer comprises 100 parts by weight of isophthalic acid-based polyol, 5 to 20 parts by weight of adipic acid and diethylene glycol-based polyol, 5 to 20 parts by weight of an HDI trimer-based isocyanate curing agent, and 1 to 30 parts by weight of a color pigment.

5. The vehicle window film of claim 1, wherein the hard coating layer comprises 100 parts by weight of an acrylate monomer and 0.1 to 5 parts by weight of a photoinitiator.

6. The vehicle window film of claim 1, wherein the adhesive layer has a thickness of 5 to 15 μm,
the first substrate layer has a thickness of 10 to 50 μm,
the color layer has a thickness of 5 to 15 μm,
the second substrate layer has a thickness of 13 to 75 μm, and
the hard coating layer has a thickness of 1 to 6 μm.

7. A method for manufacturing a vehicle window film, the method comprising: (a) forming an adhesive layer on one surface of a first substrate layer;
(b) forming a hard coating layer on one surface of a second substrate layer;
(c) forming a color layer on the other surface of the second substrate layer; and
(d) laminating the color layer on the other surface of the first substrate layer,
wherein the adhesive layer comprises a polyacrylate resin and a curing agent,
the first substrate layer and the second substrate layer each comprise a polyethylene terephthalate (PET) film,
the color layer comprises a polyurethane resin, a curing agent, and a color pigment, and
the hard coating layer comprises an acrylate monomer and a photoinitiator.

8. The method of claim 7, wherein in step (a), the adhesive layer is formed by coating the first substrate layer with a coating solution containing a polyacrylate resin and a curing agent at a temperature of 100 to 140°C and drying the coating.

9. The method of claim 7, wherein in step (b), the hard coating layer is formed by coating the second substrate layer with a coating solution containing an acrylate monomer and a photoinitiator at a temperature of 60 to 100°C and a UV light intensity of 100 to 300 mJ and drying and curing the coating.

10. The method of claim 7, wherein in step (c), the color layer is formed by coating the second substrate layer with a coating solution containing a polyurethane resin, a curing agent, and a color pigment at a temperature of 40 to 80°C and drying the coating.

11. The method of claim 7, wherein the adhesive layer comprises 100 parts by weight of the polyacrylate resin and 0.5 to 5 parts by weight of the curing agent,
the color layer comprises 100 parts by weight of isophthalic acid-based polyol, 5 to 20 parts by weight of adipic acid and diethylene glycol-based polyol, 5 to 20 parts by weight of an HDI trimer-based isocyanate curing agent, and 1 to 30 parts by weight of a color pigment, and
the hard coating layer comprises 100 parts by weight of the acrylate monomer and 0.1 to 5 parts by weight of the photoinitiator.
